(19) United States
(12) Patent Application Publication
(10) Pub. No.: US 2023/0401580 A1
(43) Pub. Date: Dec. 14, 2023

(54) SYSTEM AND METHOD FOR IDENTITY MANAGEMENT

(71) Applicant: Poku Andrew Forson, Miami, FL (US)

(72) Inventor: Poku Andrew Forson, Miami, FL (US)

(21) Appl. No.: 18/332,456

(22) Filed: Jun. 9, 2023

Related U.S. Application Data
(60) Provisional application No. 63/350,418, filed on Jun. 9, 2022.

(51) Int. Cl. G06Q 20/40; G06Q 20/38

(52) U.S. Cl. CPC G06Q 20/4014; G06Q 20/389

(57) ABSTRACT

A system and method for identity management in transactions related to commodities, assets, tokenized assets, and the like. The system allows parties in a transaction to be KYC-compliant. Details of a user for KYC can be embedded into a structure of NFT and an identity NFT representative of the KYC for the user can be minted. Any transaction by the user can be KYC validated by the identity NFT of the user.

### CROSS-REFERENCE TO RELATED APPLICATIONS

This application claims priority from a U.S. Provisional Patent Appl. No. 63/350,418 filed on Jun. 9, 2022, the disclosure of which is incorporated herein by reference to its entirety.

### FIELD OF THE INVENTION

The present invention relates to a system and method for validation of transactions, and more particularly, the present invention relates to a system and method for integrating personal identification in transactions related to commodities, real-world assets, and tokenized assets.

### BACKGROUND OF THE INVENTION

The rapid increase in the share of cryptocurrencies in global financial systems and an increasing number of frauds have mandated strict regulatory control over the ownership and redemption of fungible tokens. Many countries have barred anonymous transactions in digital currencies and mandate verified identity for ownership and redemption. Know your customer (KYC), also referred to as “know your client”, is a standard regulatory norm in financial institutions. KYC can provide several advantages, such as improved trust, prevention of money laundering, security, stability, and the like. Although the KYC process can be beneficial for cryptocurrencies, implementing the same can be difficult considering the anonymous and borderless nature of the crypto transactions. Complex and lengthy procedures in identification management for storing and transacting in cryptocurrencies can discourage customers from using cryptocurrencies. In the United States of America, KYC (Know Your Client)/CTF (Combatting Terrorist Financing)/AML (Anti-Money Laundering) is required for owning and transacting in cryptocurrencies which is a complex and time-consuming process. Any non-compliance results in several limitations and restrictions in transacting cryptocurrencies. Similar to cryptocurrencies, transacting various kinds of assets and commodities also require similar KYC requirements and pose similar limitations.

Thus, a need is there for a system and method that can conveniently and effectively manage personal identification in transactions related to commodities, real-world assets, and tokenized assets.

The term transaction(s) hereinafter refers to the transaction(s) related to commodities, real-world assets, and tokenized assets, and includes Crypto tokens, stablecoins, and NFTs.

### SUMMARY

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for integrating person identity with transactions for a seamless process.

It is another object of the present invention that the volatility in cryptocurrencies can be significantly reduced.

It is still another object of the present invention to make the process easy and scalable.

It is yet another object of the present invention that the process is easy and convenient for the customers.

It is a further object of the present invention that regulatory compliances can be effectively achieved.

It is still a further object of the present invention that the errors or omissions that in turn result in restrictions of the transaction can be prevented.

It is still a further object of the present invention that the overall cost of identity management can be significantly reduced.

It is an additional object of the present invention that the validation process and transactions can be made faster and more productive.

In one aspect, disclosed is a method for identity management, the method comprising receiving, by a registration module, through an interface, details of a user from a user, the interface implemented on a user device; embedding, by an NFT module, the details of the user in a structure of NFT; generating, by the NFT module, an identity NFT representative of KYC of the user; and linking a transaction record of a transaction with the identity NFT of the user, wherein the user is a party in the transaction. The linking of the transaction record comprises embedding a unique code in the transaction record.

### BRIEF DESCRIPTION OF THE DRAWINGS

The accompanying figures, which are incorporated herein, form part of the specification and illustrate embodiments of the present invention. Together with the description, the figures further explain the principles of the present invention and enable a person skilled in the relevant arts to make and use the invention.

FIG. 1 is a block diagram showing the environment of the system, according to an exemplary embodiment of the present invention.

FIG. 2 is a block diagram of the system, according to an exemplary embodiment of the present invention.

FIG. 3 is a flowchart illustrating a method, according to an exemplary embodiment of the present invention.

FIG. 4 is a flow chart showing an implementation of the system for stablecoins, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, the reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting to embodiments of the invention. As used herein, the singular forms “a”, “an”, and “the” are intended to include the plural forms as well, unless the context indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed are a system and method for digitally managing identity information and validation in various transactions, including day-to-day life transactions. Such transactions can be related to commodities, real-world assets, and tokenized assets, and includes Crypto tokens, stablecoins, and NFTs. The disclosed system can manage the KYC process, including the validation of transactions based on KCY providing quick and seamless transactions both nationally and internationally. The disclosed system can make the process of transacting between entities easier, quicker, and more efficient. The disclosed system and method allow meeting all KYC requirements in countries to which parties in a transaction are members. Thus, parties in a transaction, whether local or international, do not have to go through the present painstaking process of KYC validations to perform the transaction. The disclosed system uses the trustworthiness of blockchain technology for global acceptance and validation of transactions.

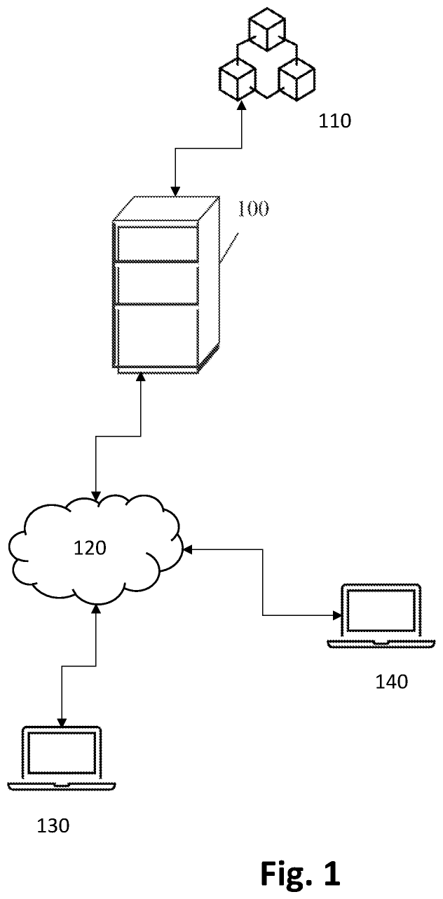

Referring to FIG. 1 is a block diagram showing the environment of the disclosed system. System 100 can be connected to a blockchain database 110 that can be used to record non-fungible tokens. The disclosed system 100 can also connect to different users through a network 120, such users can become parties to transactions that utilize the disclosed system for providing the KYC of the parties. The “user” as used herein, and throughout this disclosure, refers to an individual engaging a user device according to embodiments of the invention to interact with the disclosed system. FIG. 1 shows two user devices 130 and 140 shown connected through the network 120. Network 120 may be wired, a wireless network, or may also include a combination of wired and wireless networks. For example, network 120 may be a local area network (LAN), a wide area network (WAN), a wireless WAN, a wireless LAN (WLAN), a metropolitan area network (MAN), a wireless MAN network, a cellular data network, a cellular network, and the internet, etc. The user device can be any computing device, such as a laptop, workstation, thin client, and the like.

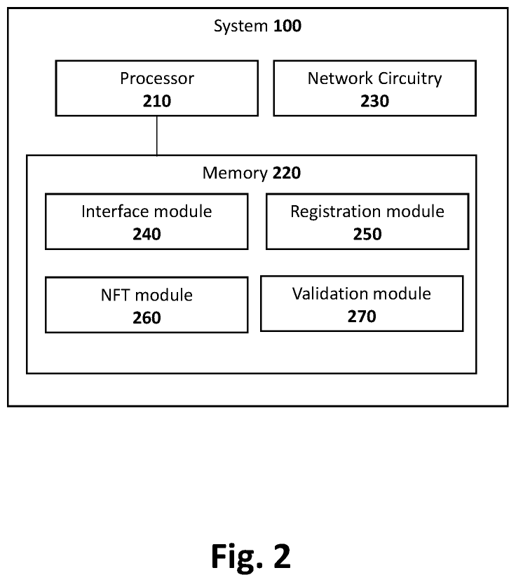

Referring to FIG. 2 is a block diagram showing the architecture of the disclosed system 100. The system includes a processor 210 and a memory 220, wherein the memory is coupled to the processor. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The system can also include network circuitry 230 for connecting to an external network, such as a network 120.

The disclosed system can also be implemented on one or more servers, wherein one or more servers can be located at one location or geographically dispersed. One or more servers can include cloud servers.

The memory can include one or more modules including an interface module 240, a registration module 250, an NFT module 260, and a validation module 270. The module herein refers to a set of instructions, which upon execution by the processer, perform one or more steps of the disclosed method. The set of instructions can include code segments in computer-readable languages; graphical and or/textual instructions; computer programs; applets; pre-compiled code; and interpreted code; compiled code. The interface module upon execution by the processor provides interfaces on the user device to allow the user to interact with the disclosed system. The interfaces can include a series of screens that can present information to the user by the system and allow the user to provide information to the system. The registration module, upon execution by the processor, allows a user to register themselves by providing personal and demographic details. The NFT module, upon execution by the processor, generates an identity NFT representing the identity of the user for KYC verification. The validation module allows for validating the transaction by embedding a unique hash or identifier.

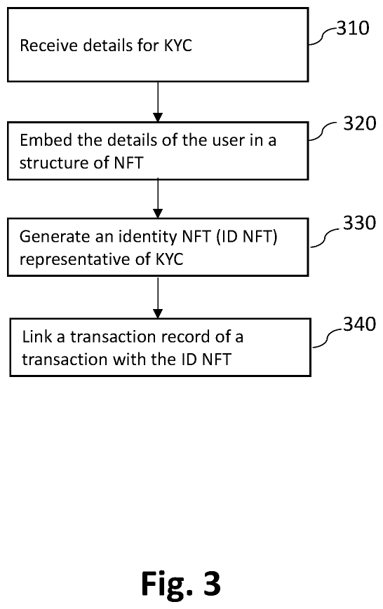

Referring to FIG. 3 is a flow chart illustrating the disclosed method. A user may require registering themselves with the disclosed system. The registration module can provide an interface on a user device that allows the user to interact and provide information to the registration module. First, the user may be provided with secured access to the disclosed system. Examples of secured access may include password-based login, token, passcodes, biometric authentication, and the like. Such methods of authenticating a user for secured access to a computer system are well-known in the art, and any such method can be used without departing from the scope of the present invention.

A screen can be presented on a user device seeking details of the user, such details include personal, demographic, and like details. Details of a person mandated by the KYC process can be at least received by the registration module, at step 310. A registration form can be presented to the user for receiving the information in a structured manner. The details include name, address, mobile number, E-mail ID, citizenship, Date of Birth, and like details. A few details, such as the IP address of the user from which the user has accessed the disclosed system can be automatically recorded by the registration module.

In case a registered user subsequently logs into the disclosed system, the registration module may seek any update or modifications in previously provided details. Should there be any change in the registered details of the user, the registration module may receive modifications through the interface from the user.

The NFT module upon receiving details of a new user, can embed the details in a structure of an NFT, at step 320. The NFT module can then generate an identity NFT for the user that represents the KYC of the user or the identity of the user, at step 330. The identity NFT can be written on the blockchain by the NFT module also referred to herein as the minting of NFT.

When updated information for a user with an identity NFT is received by the NFT module from the registration module, the NFT module can create a new identity NFT for the user. However, all the identity NFTs for a user can be linked and represented by a common identity NFT so that the modifications can be tracked with respect to date and time.

The validation module may allow for integration of KYCs of parties in a transaction, in the form of identity NFT. The validation module can embed a unique hash value or code to the transaction record, which allows tracing the transaction to the identity NFTs of the parties in the transaction, at step 340. The identity NFTs can be accessible to the parties in a transaction and entities handling the transaction. The entity handling the transaction can ensure through the identity NFT that parties in a transaction are KYC compliant. Also, since the KYC details can be updated after a transaction, the transaction can still be traced back to updated identity NFTs.

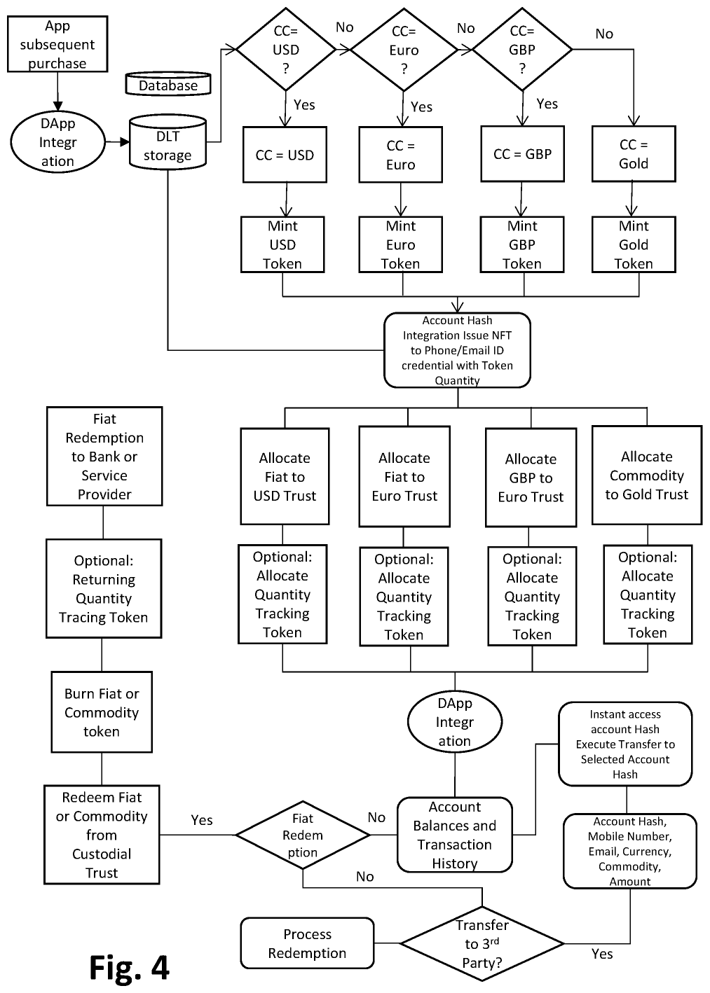

Referring to FIG. 4 is a flowchart showing an implementation of the disclosed system in a redemption process of commodity-backed tokens, also referred to as stablecoins. FIG. 4 shows crypto tokens backed by fiat currency, wherein the user has the option to choose from different currencies. Similarly, the users can be provided different options, commodities, and assets, referred to herein as products, to choose from. The choices of products made available can be administered by the platform managers.

The users who have the minted ID NFTs can choose the product and amount; the product can be a commodity or currency. The currency that may be made available to the user includes USD, Euro, GBP, and Gold. The user may also select the date. Based on the selected currency, a corresponding currency token can be minted by the system. For example, when the chosen currency is USD, a USD token can be minted. Thereafter, the disclosed system may provide for account hash integration and issue NFT.

The disclosed system and method may allow integration of the KYC validation process with all transactions on the redemption, submission, or account creation steps. The Stable element is not algorithmic—asset backing may be 1 to 1 meaning the risk of default is 0. The management of the volume or Assets Under Management relationship involves a policy of minting and burning tokens to ensure the balance is maintained.

The disclosed system and method allow users to send crypto tokens using either email or cell phone numbers exclusively, wherein such transactions are validated by identity NFT. The identity NFTs can be non-transferable NFTs containing ID information or the non-transferable NFTs linked to a Wallet. The present invention is particularly advantageous in that each and every transaction may be traceable with ID information via a hash integration between the Non-Transferable ID NFTs and the transactions representing the stable asset held.

What is claimed is:

1. A method for identity management, the method comprising:
receiving, by a registration module, through an interface, details of a user from a user, the interface implemented on a user device;
embedding, by an NFT module, the details of the user in a structure of NFT;
generating, by the NFT module, an identity NFT representative of KYC of the user; and
linking a transaction record of a transaction with the identity NFT of the user, wherein the user is a party in the transaction.

2. The method according to claim 1, wherein the linking of the transaction record comprises embedding a unique code in the transaction record.

3. A system for identity management, the system implemented within a system comprising a processor and a memory, the system configured to implement a method comprising:
receiving, by a registration module, through an interface, details of a user from a user, the interface implemented on a user device;
embedding, by an NFT module, the details of the user in a structure of NFT;
generating, by the NFT module, an identity NFT representative of KYC of the user; and
linking a transaction record of a transaction with the identity NFT of the user, wherein the user is a party in the transaction.

4. The system according to claim 3, wherein the linking of the transaction record comprises embedding a unique code in the transaction record.
